(19) United States
(12) Patent Application Publication
(10) Pub. No.: US 2015/0126233 A1
(43) Pub. Date: May 7, 2015

(54) METHOD AND APPARATUS FOR LOCATING A LOW-POWER WIRELESS DEVICE USING A SMARTPHONE

(71) Applicants: Patrick E. Burns, San Mateo, CA (US); John Peter Norair, San Francisco, CA (US)

(72) Inventors: Patrick E. Burns, San Mateo, CA (US); John Peter Norair, San Francisco, CA (US)

(21) Appl. No.: 14/071,379

(22) Filed: Nov. 4, 2013

(51) Int. Cl. H04W 4/02

(52) U.S. Cl. CPC H04W 4/02
USPC 455/457

(57) ABSTRACT

A first smartphone or electronic device may predict the location of a second electronic device using low power wireless interfaces, trilateration techniques, and global positioning system coordinates. A smartphone may detect the presence of a second electronic device using low power wireless interfaces and then communicate the predicted location to another smartphone. The low-power wireless interface may communicate in conformance with DASH7, Bluetooth, or RFID. Additional smartphones may join a search for a second electronic device with the assistance of a social networking application.

### CLAIM OF PRIORITY

This patent application makes reference to, claims priority to and claims benefit from U.S. Provisional Patent Application Ser. No. 61/796,494 entitled “Method for Location Detection Using Low-Power Wireless Communications and Smartphones” and filed on Nov. 13, 2012.

The above stated application is hereby incorporated herein by reference in its entirety.

### INCORPORATION BY REFERENCE

This patent application also makes reference to:

United States Patent Application Publication Serial No. 2012/0087267 titled “Method and Apparatus for Adaptive Searching of Distributed Datasets” and filed on Oct. 6, 2011;

United States Patent Application Publication Serial No. 2012/0087350 titled “Method and Apparatus for Low-Power, Long-Range Networking” and filed on Oct. 6, 2011;

United States Patent Application Publication Serial No. 2012/0088449 titled “Method and Apparatus for A Multi-band, Multi-mode Smartcard” and filed on Oct. 11, 2011;

United States Patent Application Publication Serial No. 2012/0086615 titled “Method and Apparatus for an Integrated Antenna” and filed on Oct. 11, 2011;

United States Patent Application Publication Serial No. 2012/0116887 titled “Method and Apparatus for Electronic Payment and Authentication” and filed on 4, 2011;

United States Patent Application Publication Serial No. 2012/0116694 titled “Method and Apparatus for Tire Pressure Monitoring” and filed on Nov. 4, 2011;

United States Patent Application Publication Serial No. 2012/0118952 titled “Method and Apparatus for Interfacing with a Smartcard” and filed on Nov. 16, 2011;

United States Patent Application Publication Serial No. 2012/0191901 titled “Method and Apparatus for Memory Management” and filed on Jan. 20, 2012;

United States Patent Application Publication Serial No. 2012/0191848 titled “Method and Apparatus for Discovering People, Products, and/or Services via a Localized Wireless Network” and filed on Jan. 20, 2012;

United States Patent Application Publication Serial No. 2013/0017788 titled “Protective Case for Adding Wireless Functionality to A Handheld Electronic Device” and filed on Jul. 13, 2012;

United States Patent Application Publication Serial No. 2012/0207141 titled “Method and Apparatus for Plug and Play, Networkable ISO 18000-7 Connectivity” and filed on Feb. 15, 2012;

United States Patent Application Publication Serial No. 2012/0209716 titled “Method and Apparatus for Serving Promotions in a Low-Power Wireless Network” and filed on Feb. 15, 2013;

United States Patent Application Publication Serial No. 2012/0226955 titled “Method and Apparatus for Forward Error Correction (FEC) in a Resource-Constrained Network” and filed on Feb. 29, 2012;

United States Patent Application Publication Serial No. 2012/0224491 titled “Method and Apparatus for Adaptive Traffic Management in a Resource-Constrained Network” and filed on Feb. 29, 2012;

United States Patent Application Publication Serial No. 2012/0224590 titled “Method and Apparatus for Dynamic Media Access Control in a Multiple Access System” and filed on Feb. 29, 2012;

United States Patent Application Publication Serial No. 2012/0224530 titled “Method and Apparatus for Rapid Group Synchronization” and filed on Feb. 29, 2012;

United States Patent Application Publication Serial No. 2012/0226822 titled “Method and Apparatus for Addressing in a Resource-Constrained Network” and filed on Feb. 29, 2012;

United States Patent Application Publication Serial No. 2012/0224543 titled “Method and Apparatus for Query-Based Congestion Control” and filed on Feb. 29, 2012; and

United States Patent Application Publication Serial No. 2012/0225687 titled “Method and Apparatus for Power Autoscaling in a Resource-Constrained Network” and filed on Feb. 29, 2012.

Each of the above-referenced applications is hereby incorporated herein by reference in its entirety.

### FIELD OF THE INVENTION

Certain embodiments of the invention relate to wireless networking. More specifically, certain embodiments of the invention relate to a method and apparatus for locating a low-power wireless device using one or more smartphones.

### BACKGROUND OF THE INVENTION

Existing methods and systems for using wireless communications to determine the location of an object are impractical for small, mobile, and inexpensive devices. Further limitations and disadvantages of such approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for determining the location of a given object containing a low-power wireless communications interface and utilizing a smartphone similarly equipped with a low-power wireless communications interface and onboard positioning capabilities (e.g., GPS), substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

FIG. 1A is a diagram illustrating an exemplary arrangement of a GPS-enabled smartphone or comparable device operable to derive the relative location of a Target Wireless Device.

FIG. 1B is a diagram illustrating an exemplary diagram illustrating an exemplary arrangement of a GPS-enabled smartphone or comparable device operable to derive the relative location of one or more Target Wireless Devices.

FIG. 1C is a diagram illustrating an exemplary arrangement of a GPS-enabled smartphone moving geographically in order to obtain additional and distinct instances of signal information to improve the predicted location of a target wireless device.

FIG. 1D is a diagram illustrating an exemplary electronic device operable to display predicted location of one or more target wireless devices.

FIG. 2A is a diagram illustrating an exemplary arrangement of GPS-enabled smartphones or comparable devices operable to derive the relative location of one or more Target Wireless Devices.

FIG. 2B is a flowchart illustrating an exemplary arrangement of GPS-enabled smartphones or comparable devices operable to derive the relative location of one or more Target Wireless Devices.

FIG. 2C is a diagram illustrating an exemplary arrangement of GPS-enabled smartphones moving geographically in order to obtain additional and distinct instances of signal information to improve the predicted location of a target wireless device

FIG. 3A is a flowchart illustrating exemplary steps for the location of one or more Target Wireless Devices using GPS-enabled smartphones distributed across large distances.

FIG. 3B is a flowchart illustrating exemplary steps locating one or more Target Wireless Devices using a social networking or comparable application to facilitate the recovery of missing or stolen objects.

FIG. 3C is a flowchart illustrating exemplary steps for locating one or more Target Wireless Devices using a dedicated individual or “bounty hunter”.

### DETAILED DESCRIPTION OF THE INVENTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be implemented in hardware, software, firmware, or any combination of one or more thereof As utilized herein, the term “exemplary” means serving as a non-limiting example, instance, or illustration. As utilized herein, the terms “e.g.,” and “for example,” introduce a list of one or more non-limiting examples, instances, or illustrations.

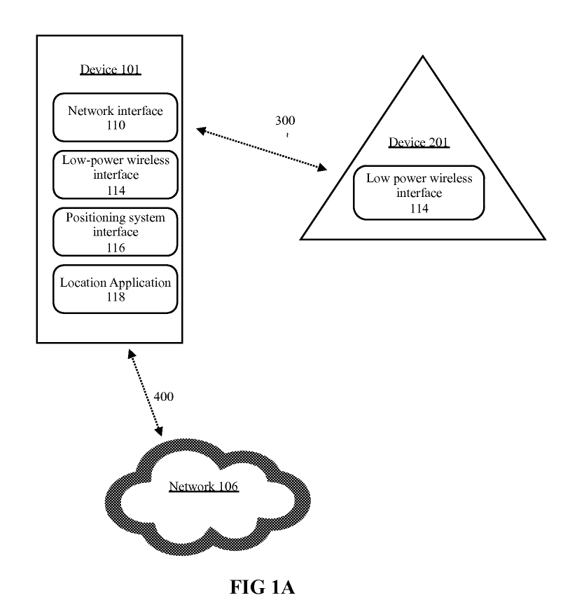

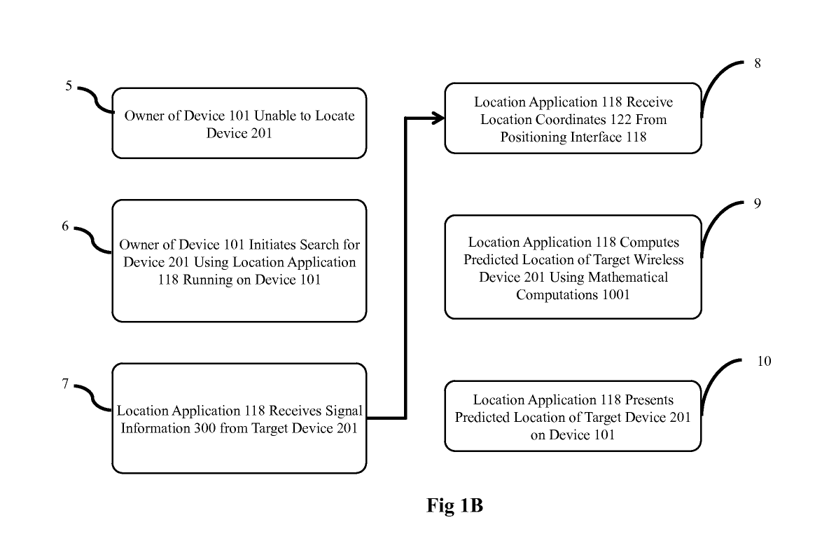

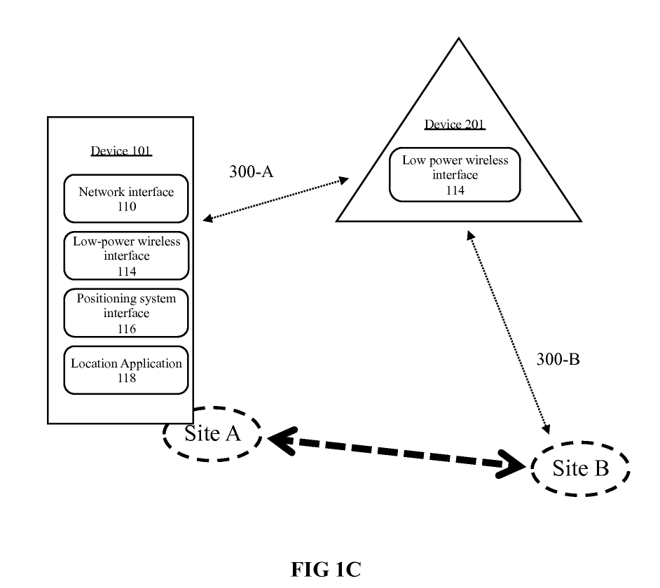

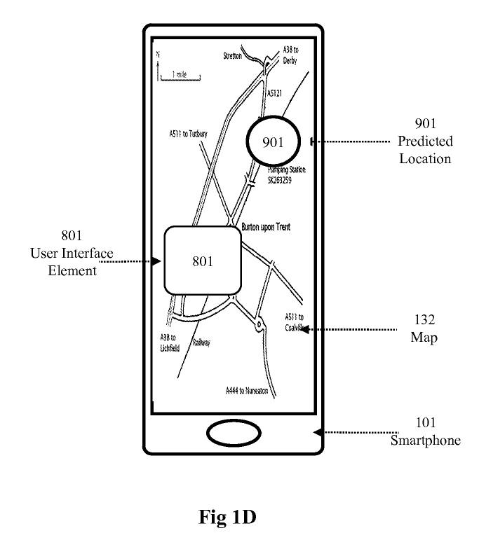

FIG. 1A is a diagram illustrating an exemplary arrangement of a single GPS-enabled smartphone or comparable device operable to derive the relative location of one or more target wireless devices. Referring to FIG. 1A there is shown device 101, Target Wireless Device 201, and communications between the two shown as signal information 300. Also shown is network 106 and communications between network 106 and device 101 as wireless link 400.

In an exemplary embodiment, the device 201 may be an end-user device such as, for example an RFID tag, an object containing an embedded RFID tag, a smartphone, a laptop computer, a wearable computer, or a tablet computer.

In an exemplary embodiment of the invention, the device 101 may be a smartphone, a laptop computer, a wearable computer, or a tablet computer.

In an exemplary embodiment of the invention, Device 101 and Device 201 both comprise a low-power wireless interface 114. The low-power wireless interface 114 comprises circuitry operable to communicate using one or more low-power wireless protocols such as protocols set forth in ISO 18000-7, DASH? Mode 2, Bluetooth Low Energy, and protocols set forth in above-incorporated U.S. Patent Application 61/464,376.

Device 101 may also comprise a network interface 110 which enables communicating via a wired or wireless link 400 to the network 106. Exemplary protocols which may be utilized by the interface 110 comprise Ethernet, WiFi, Bluetooth, cellular protocols, Universal Serial Bus, etc.

Device 101 may also comprise a positioning system interface 116 that provides real-time location coordinates 122 (see FIG. 1B) of device 101. Exemplary protocols or systems which may be utilized by interface 116 comprise a Global Positioning System (GPS), Assisted GPS, Indoor GPS, Real Time Locating Systems, and comparable systems.

Device 101 also comprises a location application 118 which consists of, for example, data and lines of code stored in memory of the Device 101, the code being executable by a processor of Device 101. In operation (i.e., when the processor of Device 101 is executing the lines of code such that the application 118 is “running” on the Device 101), the location application 118 receives signal strength, signal quality, and/or other signal information 300 from Target Wireless Device 201 via the low power wireless interface 114 present on device 101 along with location coordinates 122 (See FIG. 1B). In operation, the location application 118 causes circuitry of the Device 101 to perform mathematical computations 1001 using said inputs in order to create the predicted location 901 output.

FIG. 1B is a flowchart illustrating an exemplary embodiment of the invention, an owner or end user of Target Wireless Device 201 is unable to locate Target Wireless Device 201. The owner or end user of Target Wireless Device 201 is also the end user of device 101. The end user of device 101 initiates a search for the location of Target Wireless Device 201 utilizing location application 118 running on device 101.

In an exemplary embodiment of the invention, the Location Application 118 receives Signal Information 300 from Target Device 201, receives location coordinates 122 from positioning interface 118, and then Location Application 118 computes a predicted location 901 (See FIG. 1D) of Target Wireless Device 201 using mathematic computations 1001. The mathematic computations 1001 incorporate as input Signal Information 300 and location coordinates 122 from positioning interface 118 in order to generate as output predicted location 901 of Target Device 201.

In an exemplary embodiment of the invention, for device 101 the process depicted in this FIG. 1B is repeated and location application 118 improves the accuracy of the predicted location 901 based on newer and/or more accurate data.

FIG. 1C is a diagram illustrating an exemplary embodiment of the invention whereby to improve the accuracy of the predicted location 901, additional and distinct instances of signal information 300 are required by location application 118. To improve the probability that additional instances of signal 300 are of a higher quality than previous instances captured by location application 118, the end user of device 101 is encouraged to move device 101 to a new geographic location by carrying the device while traveling in a vehicle or on foot in the direction of the predicted location 901 of the Target Wireless Device 201. Alternatively, additional instances of signal information 300 are captured by location application 118 when Target Wireless Device 201 moves or travels while device 101 remains stationary.

The additional instances of signal information 300 are processed by location application 118 using mathematical computations 1001 including trilateration, triangulation, and comparable techniques.

As additional instances of signal information 300 are processed by location application 118 using mathematical computations 1001, the predicted location 901 of Target Wireless Device 201 is updated.

FIG. 1D is a diagram illustrating an exemplary device 101 operable to indicate the predicted location of Target Wireless Device 201 to an end user of device 101 searching for the location of wireless device 201. Device 101 displays user interface element 801 to assist the user in arriving at the actual location of Target Wireless Device 201 based on the iteratively updated inputs of signal information 300.

In an exemplary embodiment of the invention, predicted location 901 is represented as a two-dimensional field on the user interface of device 101.

In an exemplary embodiment of the invention, the predicted location 901 may be represented by an image of a circle.

In an exemplary embodiment of the invention, user interface element 801 may include text-based, graphical, video, audio, and sensory outputs. In an exemplary embodiment of the invention, the user interface element may provide a visual representation of the distance between the device 101 and the predicted location 901. For example, the size and/or orientation of the user interface element 801 may change dynamically corresponding to the distance between device 101 and predicted location 901 (e.g., Arrow may dynamically update to point in the direction of the Target Device 201 and the size of the arrow may grow and shrink as the distance changes). As another example, the user interface element may comprise one or more sub-elements and the characteristics of the sub-elements (e.g., how many are visible, how many have a particular color, etc.) may change dynamically corresponding to the distance between device 101 and predicted location 901 (e.g., more sub-elements may light up (e.g., change from an unfilled shape to a filled shape) as the distance to the Device 201 gets smaller).

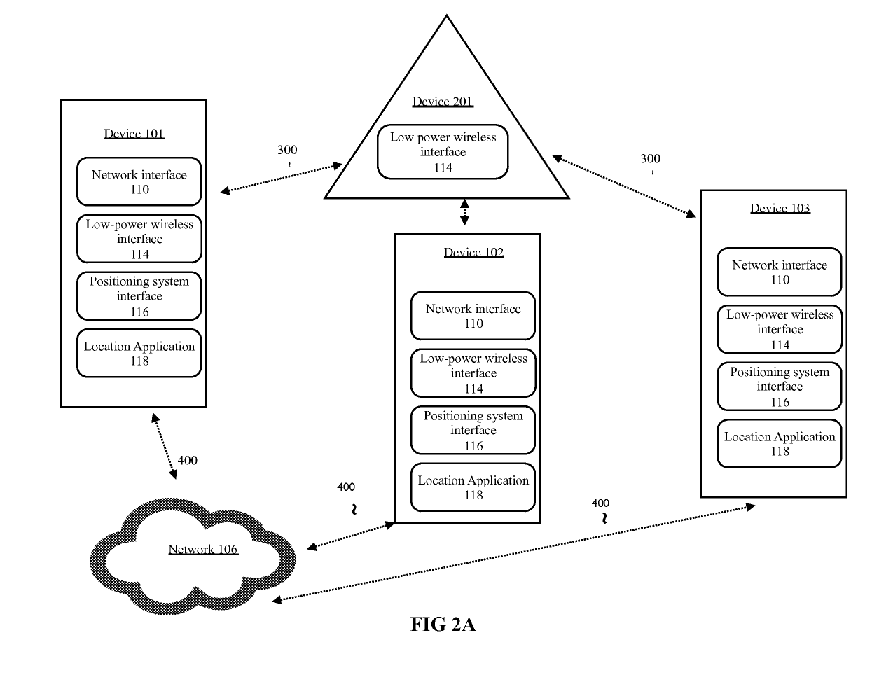

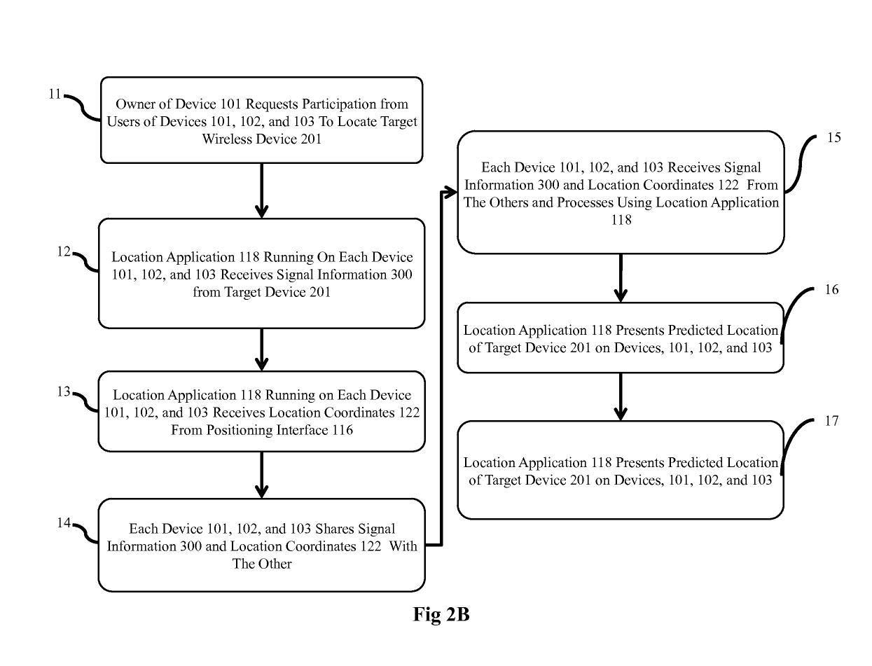

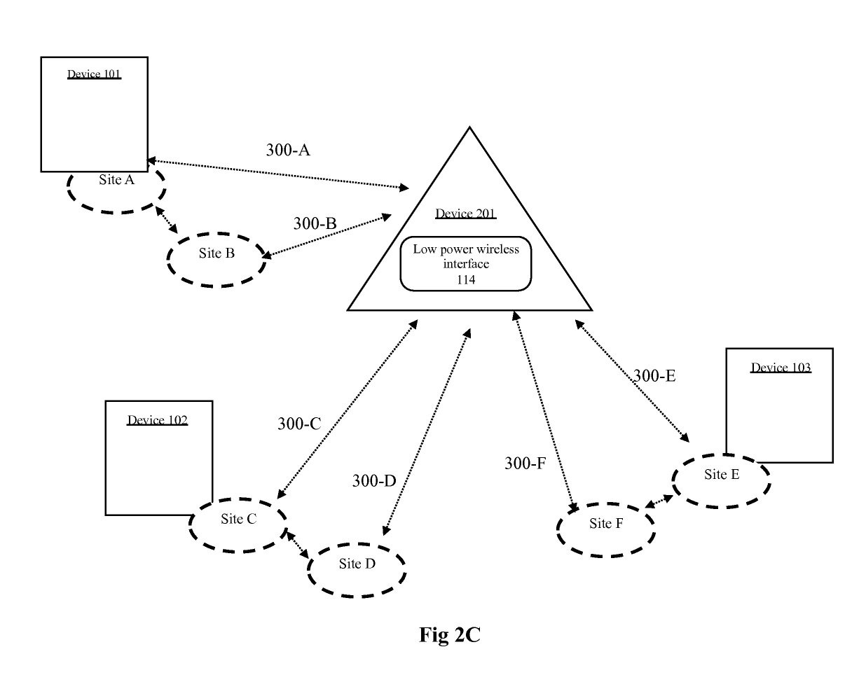

In FIG. 2A is a diagram illustrating a multiple-user approach to the exemplary illustration presented in FIG. 1A. Referring to FIG. 2A there are shown devices 101, 102, and 103, and Target Wireless Device 201. Communications with Target Wireless Device 201 by and between device 101, 102, and 103 are shown as signal information 300. Also shown are network 106 and communications with network 106 by devices 101, 102, and 103[,] represented as wireless link 400.

In an exemplary embodiment, the device 201 may be an end-user device such as, for example an RFID tag, a device containing an embedded RFID tag, a smartphone, a laptop computer, a wearable computer, or a tablet computer.

In an exemplary embodiment of the invention, the devices 101, 102, and 103 may be a smartphone, a laptop computer, a wearable computer, or a tablet computer.

In an exemplary embodiment of the invention, device 101, 102, 103 and device 201 all comprise a low-power wireless interface 114. The low-power wireless interface 114 comprises circuitry operable to communicate using one or more low-power wireless protocols such as protocols set forth in ISO 18000-7, DASH? Mode 2, Bluetooth Low Energy, and/or protocols set forth in above-incorporated U.S. Patent Application 61/464,376.

Devices 101, 102, and 103 may also comprise a network interface 110 which enables communicating via a wired or wireless link 400 to the network 106. Exemplary protocols which may be utilized by the interface 110 comprise Ethernet, WiFi, Bluetooth, cellular protocols, Universal Serial Bus, etc.

Devices 101, 102, and 103 also comprise a positioning system interface 116 that provides real-time location coordinates of device 101. Exemplary protocols or systems which may be utilized by interface 116 comprise a Global Positioning System (GPS), Assisted GPS, Indoor GPS, Real Time Locating Systems, and comparable systems.

Devices 101, 102, and 103 also comprise a location application 118. In operation, the location application 118 receives signal strength, signal quality, and/or other signal information 300 from Target Wireless Device 201 via the low power wireless interface 114 present on device 101.

FIG. 2B is a flowchart illustrating an exemplary embodiment of the invention whereby an owner or end user of Target Wireless Device 201 is unable to locate Target Wireless Device 201 and enables others to assist in the location of the Target Wireless Device 201. The owner or end user of Target Wireless Device 201 is also the end user of device 101. The end user of device 101 initiates a search for the location of Target Wireless Device 201 by requesting the participation of devices 102, 103, in the search, using location application 118 on device 101 to request their participation.

In an exemplary embodiment of the invention, in order for the other Devices 102 and 103 to be able to participate in searching for Device 201, Device 101 may share information about device 201 with the other devices 102 and 103. The information may include, for example, a unique identifier of the device 201 such that the devices 102 and 103 can distinguish signals from the device 201 from signals of other Target Wireless Devices (not shown). As another example, the Device 101 may share an encryption key and/or decryption key necessary for communicating with (and thus determining the location of) Device 201. In this regard, encryption may be used for privacy/security such that only devices authorized by the owner of Device 201 are able to communicate with (and thus determine the location of) Device 201. Where the encryption and/or decryption keys are shared with other devices 102 and 103 during a search for Device 201 (when finding the device 201 is more of a concern than the privacy of the device), the security/privacy of the Device 201 may thus be compromised. Accordingly, after the device 201 has been located, the key(s) may be changed in the Device 201 in the location app 118 such that the Device 101 is once again the only device capable of determining the location of Device 201.

In an exemplary embodiment of the invention, the location application 118 for each device 101, 102, and 103 processes signal information 300 with location coordinates 122 received from positioning interface 116 at the time signal information 300 is received by the location application 118 and computes a prediction location 901 of target device 201 using mathematical computations 1001. (See FIG. 1B)

In an exemplary embodiment of the invention, signal information 300, predicted locations 901 for the device 201, and/or location coordinates 122 from each device 101, 102, and 103 are shared between devices 101, 102, and 103 in order to provide each of devices 101, 102, and 103 with data to enable a more accurate predicted location of Target Wireless Device 201.

In an exemplary embodiment of the invention, for each device 101, 102, and 103, signal information 300 and location information 116 is then processed by the respective location application 118 residing on each device 101, 102, and 103 to provide the individual end users of each device 101, 102, and 103 with the updated predicted location of Target Wireless Device 201.

In an exemplary embodiment of the invention, predicted location 901 is represented as a two-dimensional field on the user interface of device 101. (See FIG. 1D)

In an exemplary embodiment of the invention, the predicted location 901 may be represented by a depiction of a circle. (See FIG. 1D)

In an exemplary embodiment of the invention, for each device 101, 102, and 103, the process depicted in this FIG. 2B is repeated and location application 118 improves the accuracy of the predicted location 901 based on newer and/or more accurate data.

FIG. 2C is a diagram illustrating an exemplary embodiment of the invention whereby to improve the accuracy of the predicted location 901, additional and distinct instances of signal information 300, represented as signal information 300-A, 300-B, 300-C, 300-D, 300-E, and 300-F, are required by location application 118 for each device 101, 102, and 103. To improve the probability that additional instances of signal 300 are of a higher quality than previous instances captured by location application 118, the end users of devices 101, 102, and 103 are encouraged to move their respective devices 101, 102, and 103 from one geographic location (e.g. Site A, Site C, Site E) to and/or in the direction of a new geographic location (e.g. Site B, Site D, Site F) by carrying or otherwise transporting the device while traveling in a vehicle or on foot in the direction of the predicted location 901 of the Target Wireless Device 201. Alternatively, additional instances of signal information 300 are captured by location application 118 when Target Wireless Device 201 moves while devices 101, 102, and 103 are stationary.

The additional instances of signal information 300 are processed by location application 118 using mathematical computations 1001 including trilateration, triangulation, and comparable techniques.

As additional instances of signal information 300 are processed by location application 118 using mathematical computations 1001, the predicted location 901 of Target Wireless Device 201 is updated.

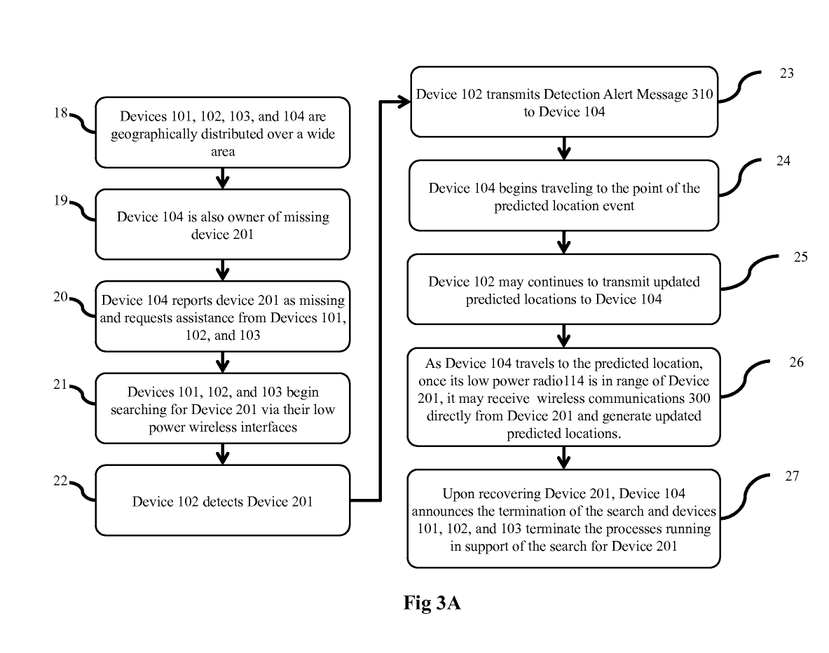

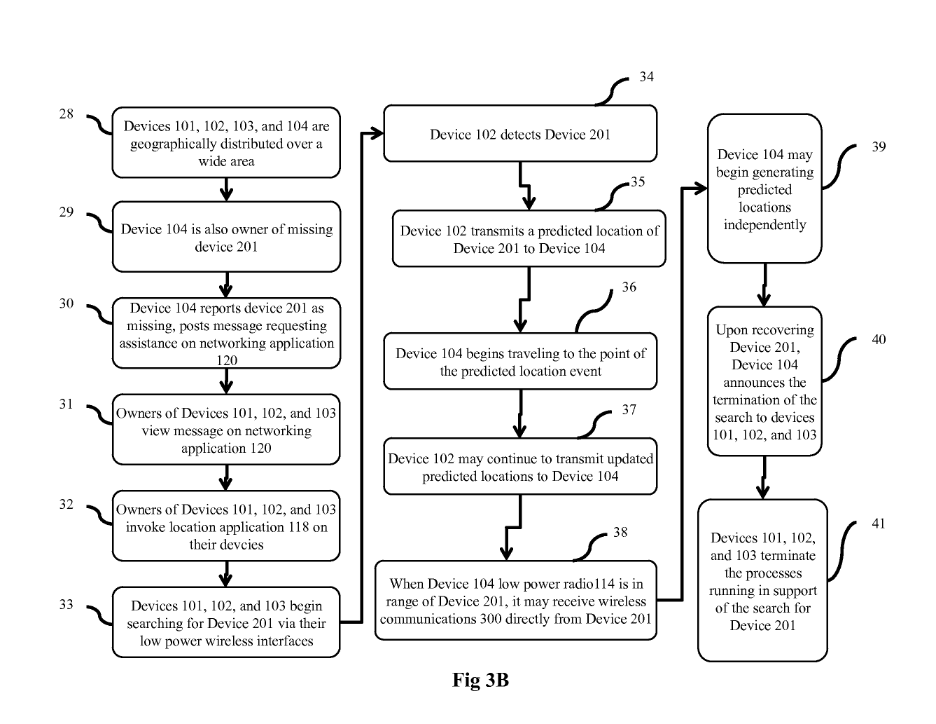

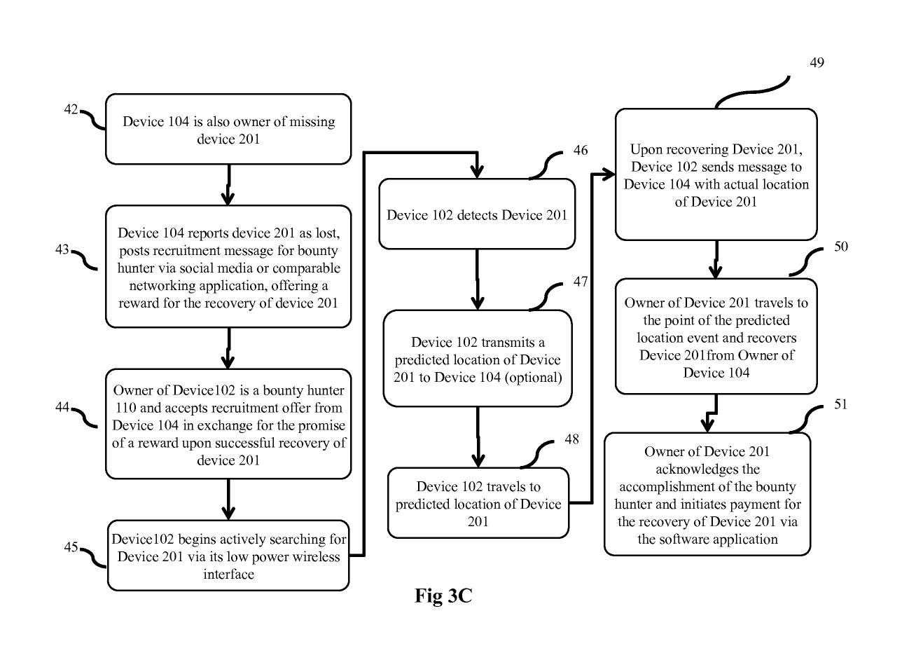

FIG. 3A is a flowchart illustrating an exemplary variation on the approach to the exemplary illustration presented in FIG. 2A whereby devices 101, 102, 103, and 104 are distributed over a large geographic area.

In an exemplary embodiment of the invention, devices 101, 102, 103, and 104 are geographically situated no fewer than, for example, 100 kilometers apart

In an exemplary embodiment of the invention, devices 101, 102, 103, and 104 are controlled by end users capable of moving the devices in a vehicle or on foot within or across a campus, city, metropolitan, or wider geographic area.

In an exemplary embodiment of the invention, devices 101, 102, 103, and 104 are running location application 118.

In an exemplary embodiment of the invention, the devices 101, 102, 103, and 104 may be a smartphone, a laptop computer, a wearable computer, or a tablet computer and/or may be an access point and/or other device which resides in a public and/or commercial place. For example, one or more of the devices 101, 102, 103, and 104 may be an access point which resides, for example, in a retail store, at a bus stop, on a bus, on a train, in an airport terminal, etc.

In operation, the location application 118 for each device 101, 102, 103, and 104 is enabled to receive signal strength, signal quality, and/or other signal information 300 from Target Wireless Device 201 via the low power wireless interface 114 present on devices 101, 102, 103, and 104.

In operation, the location application 118 is also capable of transmitting and receiving requests for assistance in locating a lost target device 201.

In an exemplary embodiment of the invention, the device 201 may be an end-user device such as, for example an RFID tag, a device with an embedded RFID tag, a smartphone, a laptop, a wearable computer, or a tablet.

In an exemplary embodiment of the invention, the owner or end user of Target Wireless Device 201 is also the end user of device 104.

In an exemplary embodiment of the invention, an owner or end user of Target Wireless Device 201 discovers that Target Wireless Device 201 is missing. The search for the location of Target Wireless Device 201 is initiated by requesting the participation of devices 101, 102, and 103 in the search using location application 118 on device 104 to request participation.

In an exemplary embodiment of the invention, in requesting the participation of other devices to participate in the search, location application 118 on device 101 transmits a participation request message to devices 101, 102, and 103 via network 106. The request message may include, for example, information that enables the devices 101, 102, and 103 to communicate with the Device 201 (e.g., unique identifier, encryption key, decryption key, and/or the like), information about the last known whereabouts of the Device 201, an image or other identifying information about the Device 201, and/or other information.

In an exemplary embodiment of the invention, devices 101, 102, and 103 receive the participation request generated by device 104.

In an exemplary embodiment of the invention, Devices 101, 102, and 103 are configured to participate in searches for Target Wireless Device 201 on an automatic basis, meaning there is no interaction required on the part of the end user of devices 101, 102, or 103 in order for those devices to participate in a search and participation may optionally occur without active knowledge or intervention by the end users of devices 101, 102, and 103.

In an exemplary embodiment of the invention, devices 101, 102, and 103 may be alternatively be configured to participate in searches for such wireless devices as Target Wireless Device 201 at the option of the user or owner of the devices.

In an exemplary embodiment of the invention, in the instance of devices 102 and 103 participating on an automatic basis, devices 102 and 103 are engaged in the search process without the active intervention of the end users of devices 102 and 103.

In an exemplary embodiment of the invention, and using its low power wireless interface 114, device 102 receives signal information 300 from device 201. Device 102 generates a detection alert message 310 that is transmitted via wireless link 400 to Network 106. Detection message 310 contains information including the confirmation of the detection event, the location of the device 102 at the time of detection, the predicted location of target device 201, and/or other data relevant to the detection event to assist the search participants.

In an exemplary embodiment of the invention, the end user of device 104 views the incoming alert message and invokes a web browser following a hyperlink or comparable action included in the alert message. Upon invoking the hyperlink, a map 132 and the predicted location of target device 201 overlaid upon map 132 are presented, along with directions to the predicted location, estimated time of arrival, and other relevant data.

In an exemplary embodiment of the invention, as device 102 or device 103 provide updated detections of Target Wireless Device 201, new alerts are transmitted to device 101 in order to refresh the predicted location of 201 and facilitate the recovery of Target Wireless Device 201.

In an exemplary embodiment of the invention, upon recovering Target Wireless Device 201, the owner or end user of device 104 terminates the search using location application 118, resulting in a termination message sent to devices 102 and 103 which upon receipt, results in the termination of the search for target device 201. Upon termination information for communicating with Device 201 may be deleted from the non-owner devices 101, 102, and 103 and/or may be changed in the Device 201 and Device 104 such that Devices 101, 102, and 103 can no longer track the location of Device 201.

FIG. 3B. is a flowchart illustrating exemplary steps for locating Target Wireless Device 201 using a social networking application like Facebook, a network-enabled software application designed to facilitate the recovery of lost or stolen objects, or comparable networking application, hereafter referred to as networking application 120, in conjunction with a low power wireless interface 114 and other location methods illustrated in FIG. 2A.

In an exemplary embodiment of the invention, the owners or end users of devices 101, 102, and 103 may be notified or otherwise made aware of the search for Target Wireless Device 201 via networking application 120.

In an exemplary embodiment of the invention, upon being notified of the search for Target Wireless Device 201 via networking application 120, users of the application invoke location application 118 on their devices 101, 102, and 103, or the location application 118 is invoked automatically through a hyperlink or other call to action present in the social networking application.

In an exemplary embodiment of the invention, location application 118 may optionally be integrated with networking application 120 as a single application.

In an exemplary embodiment of the invention, the networking application 120 may also award points, badges, or comparable incentives to users of that networking application 120 that participate in the search for Target Wireless Device 201.

In an exemplary embodiment of the invention, the networking application 120 may facilitate between its users the advertisement and payment, of rewards for the successful recovery of Target Wireless Device 201. Rewards may be monetary or non-monetary and may change based on the number of users of a networking application 120 using the system, the age of the search in hours or days, the geographical breadth or density of the networking application 120 users involved in the search, and the reputation of the networking application 120 users involved in the search. Similarly, the networking application 120 may facilitate between its users the scoring of participant reputations and dispute resolution.

FIG. 3C. is a flowchart illustrating exemplary steps for locating Target Wireless Device 201 using a dedicated individual, hereafter referred to as bounty hunter 110, participating in networking application 120.

In an exemplary embodiment of the invention, the networking application 120 facilitates the recruitment of one or more specific bounty hunters 110 dedicated to locating Target Wireless Device 201. For example, networking application 120 may present bounty hunter 110 with an opportunity to earn a reward for a successful search or recovery of missing Target Wireless Device 201, wherein the opportunity matches or corresponds to pre-set preferences or criteria created by bounty hunter 110 including but not limited to types of searches bounty hunter 110 might find attractive, minimum reward values, temporal availability, geographic availability, exclusivity of the opportunity relative to other bounty hunters 110, etc.

In an exemplary embodiment of the invention, each bounty hunter 110 may require unique contractual terms for participating in a search for Target Wireless Device 201 and may advertise those terms within the networking application 120.

In an exemplary embodiment of the invention, the owner of Target Wireless Device 201 may utilize networking application 120 to negotiate contractual terms for participating in a search for Target Wireless Device 201 with bounty hunter 110. Similarly, and in an exemplary embodiment of the invention, bounty hunter 110 may bid against other bounty hunters to secure exclusive or semi-exclusive participation in the search for Target Wireless Device 201. For example, networking application 120 may present multiple bounty hunters 110 with the opportunity to earn a reward for a successful search or recovery of missing Target Wireless Device 201, wherein multiple bounty hunters 110 respond to the presentation and indicate their respective minimum reward requirements, out of pocket expense requirements, exclusivity requirements, and the owner of Target Wireless Device 201 may either accept one or more responses or request modifications in the responses from one or more bounty hunters 110.

In an exemplary embodiment of the invention, the networking application 120 may facilitate voice, text, graphical, or video communications between the owner or end user of Target Wireless Device 201 and the bounty hunter 110.

Upon successful recovery of Target Wireless Device 201, networking application 120 may facilitate the payment of a reward to the bounty hunter 110.

What is claimed is:

1. A system comprising:
a first smartphone or tablet that is configured to:
communicate directly with an electronic tag via a wireless interface, wherein said communication with said electronic tag requires secure information associated with said electronic tag;
generate a first predicted location of said electronic tag based on characteristics of a signal received from said electronic tag during said communication;
present, via a display of said first smartphone or tablet, a graphical interface element that represents a distance to said first predicted location of said electronic tag.

2. The system of claim 1, wherein said first smartphone or tablet is configured to present, via said display, a graphical user interface that enables a user of said first smartphone or tablet to share said secure information with one or more other smartphones or tablets so as to control access to location information of said electronic tag.

3. The system of claim 1, wherein said determination of said distance is uses trilateration and/or triangulation techniques.

4. The system of claim 1, wherein said first smartphone or tablet is configured to present, via said display, a graphical interface element that instructs said user of said first smartphone or tablet to move toward said first predicted location of said electronic tag.

5. The system of claim 4, wherein said first smartphone or tablet is configured to update said first predicted location and said graphical interface element as said first smartphone or tablet moves toward said first predicted location and receives additional signals from said electronic tag.

6. The system of claim 4, wherein said first smartphone or tablet is configured to present, via said display, a graphical interface element that represents said first predicted location of said electronic tag.

7. The system of claim 6, wherein said first smartphone or tablet is configured to update said graphical interface element that represents said first predicted location as said first smartphone or tablet moves toward said first predicted location and receives additional signals from said electronic tag.

8. The system of claim 1, wherein said wireless interface is a Bluetooth interface.

9. The system of claim 1, wherein said wireless interface is a Dash7 interface.

10. The system of claim 1, wherein said smartphone is configured to communicate said first predicted location and/or said characteristics of said signal received from said electronic tag to a second smartphone or tablet.

11. The system of claim 1, wherein said smartphone is configured to receive one or both of:
from a second smartphone or tablet, a second predicted location of said electronic tag generated by said second smartphone or tablet; and
from said second smartphone or tablet, characteristics of a signal received by said second smartphone or tablet from said electronic tag.

12. The system of claim 11, wherein said smartphone is configured to update said first predicted location based on said second predicted location and/or based on said characteristics of said signal received by said second smartphone or tablet.

13. The system of claim 1, wherein said wireless interface is integrated in a protective case that a user of said first smartphone or tablet can attach and detach from said first smartphone or tablet.

14. A system comprising:
a network computing device that configured to:
receive, from a first smartphone or tablet, characteristics of a signal received by said first smartphone or tablet directly from said electronic tag;
receive, from a second smartphone or tablet, characteristics of a signal received by said second smartphone or tablet directly from said electronic tag;
generate a predicted location of said electronic tag based on said characteristics received from said first smartphone or tablet and said characteristics received from said second smartphone or tablet; and
communicate said predicted location to said first smartphone or tablet and said second smartphone or tablet.

15. A method comprising:
in a first smartphone or tablet that comprises a wireless interface and a display:
receiving, from a second smartphone or tablet, a request that first second smartphone participate in a search for an electronic tag;
in response to said request, attempting to communicate with said electronic tag via said wireless interface; and
when said attempt to communicate with said tag is successful, generating a predicted location of said electronic tag based on a signal received directly from said electronic tag, and sending said predicted location to said second smartphone or tablet.

16. The method of claim 15, wherein said attempting to communicate comprises powering up said wireless interface in response to said request

17. The method of claim 16, wherein said attempting to communicate occurs automatically, without intervention by a user of said first smartphone or tablet.

18. The method of claim 15, wherein said request includes an offer of a reward for locating said electronic tag.

19. The method of claim 15, wherein said request includes a picture of an object to which said electronic tag is attached.

20. The method of claim 15, comprising:
during said search for said electronic tag, automatically posting updates related to said search to a chat or blog that is dedicated to said search for said electronic tag.
